(19) United States
(12) Patent Application Publication
(10) Pub. No.: US 2010/0269640 A1
(43) Pub. Date: Oct. 28, 2010

(54) Wrench with bolt engaging portion and roller

(76) Inventor: Glenn Robinson, Coral Springs, FL (US)

Correspondence Address: Dan M. DeLa Rosa, Esq., Suite 24C, 300 E 77th Street, New York, NY, 10075, US

(21) Appl. No.: 12/590,733

(22) Filed: Nov. 16, 2009

Related U.S. Application Data
(60) Provisional application No. 61/214,395, filed on Apr. 24, 2009.

(51) Int. Cl. B25B 13/46; B25B 13/08

(52) U.S. Cl. 81/59.1; 81/125.1

(57) ABSTRACT

A wrench with a ratcheting device is provided, and the wrench comprises: a handle having opposing ends; and two bolt engaging members situated on opposing ends of the handle, each of the members comprises at least two stationary jaws forming a space and at least one cavity with an opening situated adjacent one of the stationary jaws, each of the members comprising a ratcheting device with at least one roller, and the roller is designed to be situated within the cavity of the member, at least a portion of the roller is adapted to protrude from the opening, at least one of the jaws has an extended portion with flat, angled tip, and the tip is designed to initiate engagement with a bolt and allow the bolt to enter into the space between the jaws and allow the exposed portion of the roller to contact the bolt and allow for a ratcheting action.

### RELATED APPLICATION

This application is related to U.S. Application Ser. No. 61/214,395 which was filed on Apr. 24, 2009 and entitled “Wrench with Bolt Engaging Portion and Roller”.

### BACKGROUND OF THE INVENTION

1. Field of the Invention

This invention relates to a box wrenches and more specifically, to a wrench with a bolt engaging portion and rollers.

2. Description of the Related Art

There are various patents that utilize rollers or wheels to create ratcheting actions. These prior art references include U.S. Pat. No. 2,806,488 to Ahana, U.S. Pat. No. 4,574,665 to Blachly, U.S. Pat. No. 6,739,223 to Wu and U.S. Pat. No. 7,010,999 to Wu.

There has been no invention that utilizes rollers that are effective with box wrenches or wrenches with two stationary jaws. The Wu patents work with adjustable wrenches but not box wrenches. The present invention provides for a solution to these problems.

### SUMMARY OF THE INVENTION

In one embodiment, the present invention provides for a wrench comprising: a handle having opposing ends; at least one bolt engaging member situated on one end of the handle, and the member comprises at least two stationary jaws forming a space and at least one cavity with an opening situated adjacent one of the stationary jaws; and a ratcheting device comprising at least one roller and at least one spring, the roller and the spring designed to be situated within the cavity of the member, and at least a portion of the roller is adapted to protrude from the opening, at least one of the jaws has an extended portion with flat, angled tip, and the tip is designed to initiate engagement with a bolt and allow the bolt to enter into the space between the jaws and allow the exposed portion of the roller to contact the bolt and allow for a ratcheting action.

In another embodiment, the wrench further comprises a cover plate for covering the cavity on the member. In yet another embodiment, the wrench is a box wrench.

In still another embodiment, the wrench further comprises a second bolt engaging member situated on the second opposing end of the handle, and the second member comprises at least two stationary jaws forming a space and at least one cavity with an opening situated adjacent one of the stationary jaws.

In still yet another embodiment, the wrench further comprises a second ratcheting device comprising at least one roller and at least one spring, and the roller and the spring are designed to be situated within the cavity of the member, and at least a portion of the roller is adapted to protrude from the opening, and at least one of the jaws has an extended portion with flat, angled tip.

In a further embodiment, the wrench further comprises a means for securing the cover plate to the member. In another further embodiment, the wrench further comprises a second cover plate for covering the cavity on the second member. In yet another further embodiment, the wrench further comprises means for securing the second cover plate to the second member.

In still another further embodiment, the present invention provides for a box wrench comprising: a handle having opposing ends; and two bolt engaging members situated on opposing ends of the handle, each of the members comprises at least two stationary jaws forming a space and at least one cavity with an opening situated adjacent one of the stationary jaws, each of the members comprises a ratcheting device with at least one roller, and the roller is designed to be situated within the cavity of the member, at least a portion of the roller is adapted to protrude from the opening, at least one of the jaws has an extended portion with flat, angled tip, and the tip is designed to initiate engagement with a bolt and allow the bolt to enter into the space between the jaws and allow the exposed portion of the roller to contact the bolt and allow for a ratcheting action.

In still yet another further embodiment, the jaw with extended portion is longer in length than the jaw with no extended portion. In another embodiment, the roller is situated adjacent jaw with the extended portion with the tip.

In still another embodiment, the box wrench further comprises at least two cover plates for covering the cavities on each of the members. In yet another embodiment, the box wrench further comprises a means for securing said cover plates to the members. In still yet another embodiment, the means for securing the cover plates to the members is selected from a group consisting essentially of pins, screw, and bolts.

In a further embodiment, the ratcheting device further comprises at least two springs, each of the springs is assembled with each of the rollers and situated within each of the cavities in each of the members.

In another embodiment, the space between said jaws of said first engaging member is a different size from said space between said jaws of said second engaging member, said sizes allow for use with different size bolts. In a further embodiment, each of the cavities comprises at least two compartments. In still a further embodiment, at least a portion of each of the rollers moves from one compartment to the second compartment, and then back to the first compartment during its engagement with a bolt and during the ratcheting action.

In yet a further embodiment, the present invention provides for a wrench comprising: a handle having opposing ends; at least one bolt engaging member situated on one end of the handle, and the member comprises at least one stationary jaw with at least one cavity with an opening and two compartments; and a ratcheting device comprising at least one roller and at least one spring, and the roller and the spring are designed to be situated within the cavity of the member, and at least a portion of the roller is adapted to protrude from the opening, and the jaw has an extended portion with flat, angled tip, and roller is situated adjacent the tip, and the tip is designed to initiate engagement with a bolt and allow the bolt to contact the roller and allow for a ratcheting action.

In another embodiment, at least a portion of the roller moves from one compartment to the second compartment, and then back to the first compartment during its engagement with a bolt and during the ratcheting action. In a further embodiment, the member comprises a second stationary jaw situated at a certain distance away from the first jaw to thereby create a space between said jaws. In another embodiment, the spring is situated within the second compartment of the cavity.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is perspective view of the wrench of the present invention with the its extended tip and roller;

FIG. 2 is a perspective view of FIG. 1 showing the cavity without the cover plate and exposing the spring and roller;

FIG. 3 is an exploded view of one of the embodiments of the box wrench of the present invention; and

FIGS. 4a-d are perspective views of the how the extended tip and roller functions with a bolt.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention are disclosed herein; however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

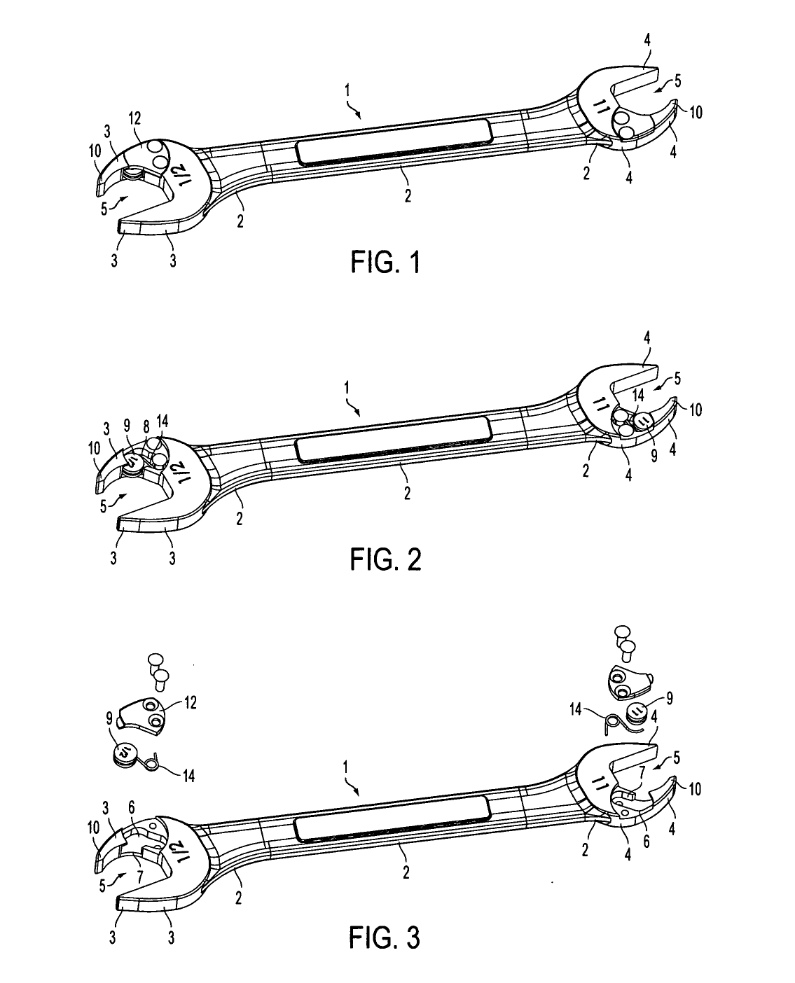

FIGS. 1, 2 & 3 illustrate the wrench 1 of the present invention. The wrench 1 comprises: a handle 2 having opposing ends, 2a and 2b respectively; and two bolt engaging members, 3 and 4, situated on opposing ends of the handle 2. The members, 3 and 4, comprises at least two stationary jaws, 3a, 3b, 4a and 4b, forming a space 5 and at least one cavity 6 with an opening 7 situated adjacent one of the stationary jaws. Each of the members, 3 and 4, comprises a ratcheting device 8 with at least one roller 9, and the roller 9 is designed to be situated within the cavity 6 of one of the members, 3 or 4. At least a portion of the roller 9 is adapted to protrude from the opening 7, and at least one of the jaws, 3a, 3b, 4a or 4b, has an extended portion with flat, angled tip 10. The tip 10 is designed to initiate engagement with a bolt 11 and allow the bolt 11 to enter into the space 5 between the jaws, 3a and 3b, or 4a and 4b and allow the exposed portion of the roller 9 to contact the bolt 11 and allow for a ratcheting action. The wrench 1 further comprises a cover plate 12 for covering the cavity 6 on one of the members, 3 or 4.

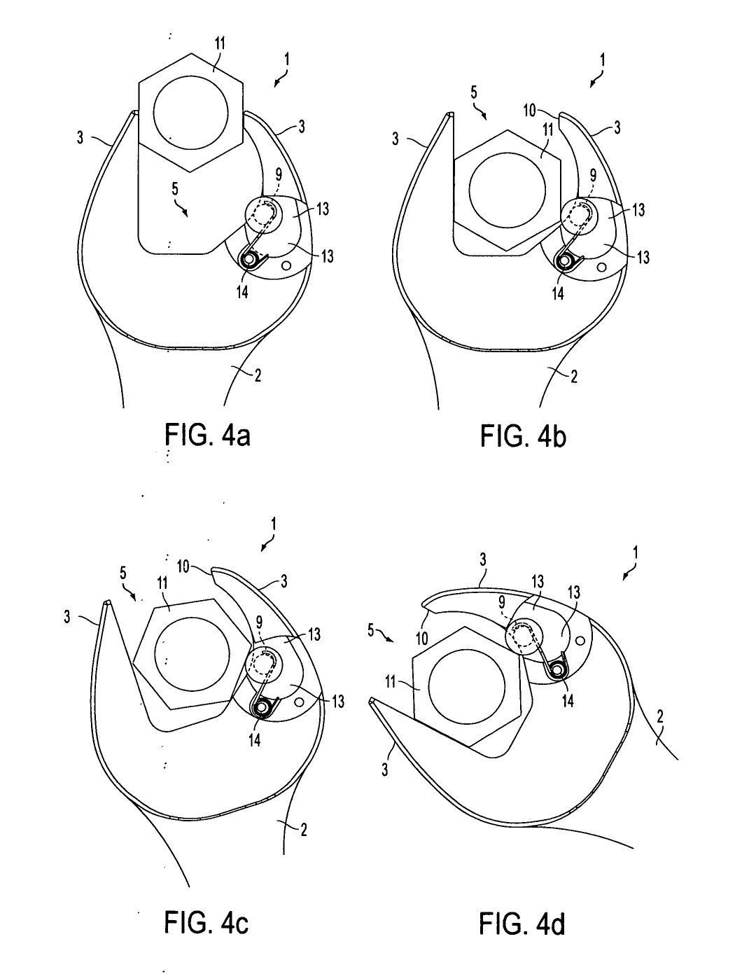

FIGS. 4a-d show how the wrench 1 of the present invention functions with a bolt 11. The wrench 1 comprises: a handle 2 with at least one bolt engaging member 3 situated on one end 2a of the handle 2, and the member 3 comprises at least one stationary jaw 3a with at least one cavity 6 with an opening 7 and two compartments 13a and 13b; and a ratcheting device 8 comprising at least one roller 9 and at least one spring 14. The roller 9 and the spring 14 are designed to be situated within the cavity 6 of the member 3, and at least a portion of the roller 9 is adapted to protrude from the opening 7. The jaw 3a has an extended portion with flat, angled tip 10, and roller 9 is situated adjacent the tip 10. As shown in FIG. 4a, the tip 10 is designed to initiate engagement with a bolt 11 and allow the bolt 11 to contact the roller 9 and allow for a ratcheting action (as shown in FIGS. 4b-d). The roller 9 is initially situated in the first compartment 13a and the spring 14 is situated within the second compartment 13b (FIG. 4b). During the ratcheting action, the bolt 11 pushes upon the roller 9 wherein a portion of the roller 9 goes into the second compartment 13b (FIG. 4c). The spring 14 pushes upon the roller 9 to thereby facilitate the ratcheting movement of the bolt 11 (FIG. 4d).

Numerous modifications and variations of the present invention are possible in light of the above teachings. It is therefore to be understood that within the scope of the attendant claims attached hereto, this invention may be practiced otherwise than as specifically disclosed herein.

What is claimed is:

1. A wrench comprising:
a handle having opposing ends;
at least one bolt engaging member situated on one end of said handle, said member comprising at least two stationary jaws forming a space and at least one cavity with an opening situated adjacent one of said stationary jaws; and
a ratcheting device comprising at least one roller and at least one spring, said roller and said spring designed to be situated within said cavity of said member, at least a portion of said roller being adapted to protrude from said opening, at least one of said jaws having an extended portion with flat, angled tip, said tip is designed to initiate engagement with a bolt and allow the bolt to enter into said space between said jaws and allow said exposed portion of said roller to contact the bolt and allow for a ratcheting action.

2. The wrench of claim 1 further comprising a cover plate for covering said cavity on said member.

3. The wrench of claim 1 wherein said wrench is a box wrench.

4. The wrench of claim 1 further comprising a second bolt engaging member situated on said second opposing end of said handle, said second member comprising at least two stationary jaws forming a space and at least one cavity with an opening situated adjacent one of said stationary jaws.

5. The wrench of claim 4 further comprising a second ratcheting device comprising at least one roller and at least one spring, said roller and said spring designed to be situated within said cavity of said member, at least a portion of said roller being adapted to protrude from said opening, at least one of said jaws having an extended portion with flat, angled tip.

6. The wrench of claim 2 further comprising means for securing said cover plate to said member.

7. The wrench of claim 5 further comprising a second cover plate for covering said cavity on said second member.

8. The wrench of claim 7 further comprising means for securing said second cover plate to said second member.

9. A box wrench comprising:
a handle having opposing ends; and
two bolt engaging members situated on opposing ends of said handle, each of said members comprising at least two stationary jaws forming a space and at least one cavity with an opening situated adjacent one of said stationary jaws, each of said members comprising a ratcheting device with at least one roller, said roller designed to be situated within said cavity of said member, at least a portion of said roller being adapted to protrude from said opening, at least one of said jaws having an extended portion with flat, angled tip, said tip is designed to initiate engagement with a bolt and allow the bolt to enter into said space between said jaws and allow said exposed portion of said roller to contact the bolt and allow for a ratcheting action.

10. The box wrench of claim 9 wherein said jaw with extended portion is longer in length than said jaw with no extended portion.

11. The box wrench of claim 9 wherein said roller is situated adjacent jaw with said extended portion with said tip.

12. The box wrench of claim 9 further comprising at least two cover plates for covering said cavities on each of said members.

13. The box wrench of claim 12 further comprising means for securing said cover plates to said members.

14. The box wrench of claim 13 wherein said means for securing said cover plates to said members is selected from a group consisting essentially of pins, screw, and bolts.

15. The box wrench of claim 9 wherein said ratcheting device further comprises at least two springs, each of said springs being assembled with each of said rollers and situated within each of said cavities in each of said members.

16. The box wrench of claim 9 wherein said space between said jaws of said first engaging member is a different size from said space between said jaws of said second engaging member, said sizes allow for use with different size bolts.

17. The box wrench of claim 9 wherein each of said cavities comprises at least two compartments.

18. The box wrench of claim 17 wherein at least a portion of each of said rollers moves from one compartment to said second compartment and then back to said first compartment during its engagement with a bolt and said ratcheting action.

19. A wrench comprising:
a handle having opposing ends;
at least one bolt engaging member situated on one end of said handle, said member comprising at least one stationary jaw with at least one cavity with an opening and two compartments; and
a ratcheting device comprising at least one roller and at least one spring, said roller and said spring designed to be situated within said cavity of said member, at least a portion of said roller being adapted to protrude from said opening, said jaw having an extended portion with flat, angled tip, said roller being situated adjacent said tip, said tip being designed to initiate engagement with a bolt and allow the bolt to contact said roller and allow for a ratcheting action.

20. The wrench of claim 19 wherein at least a portion of said roller moves from one compartment to said second compartment and then back to said first compartment during its engagement with a bolt and said ratcheting action.
